(19) United States
(12) Patent Application Publication
(10) Pub. No.: US 2012/0159397 A1
(43) Pub. Date: Jun. 21, 2012

(54) APPARATUS AND METHOD FOR PROVIDING APPLICATION INFORMATION AND EXECUTING APPLICATION IN MOBILE TERMINAL HAVING TOUCH SCREEN

(75) Inventors: Jin-Hee LEE, Gyeonggi-do (KR); Su-Jin KIM, Seoul (KR); Myoung-Ju LEE, Gyeonggi-do (KR)

(73) Assignee: Samsung Electronics Co., LTD., Gyeonggi-Do (KR)

(21) Appl. No.: 13/313,164

(22) Filed: Dec. 7, 2011

(30) Foreign Application Priority Data
Dec. 15, 2010 (KR) 10-2010-0128501

(51) Int. Cl. G06F 3/048

(52) U.S. Cl. 715/841

(57) ABSTRACT

An apparatus and a method for outputting information regarding an application installed in advance or an application that is being executed on a current output screen according to a user's simple input without exiting a current screen and back to a main screen, and selecting a specific application from an output application list to execute the application in a mobile terminal are provided.

### CLAIM OF PRIORITY

This application claims the benefit under 35 U.S.C. §119 of a Korean patent application filed in the Korean Intellectual Property Office on Dec. 15, 2010 and assigned Serial No. 10-2010-0128501, the entire disclosure of which is hereby incorporated by reference in its entirety.

### BACKGROUND OF THE INVENTION

1. Field of the Invention

The present invention relates to an apparatus and a method for providing information regarding an application installed in advance or an application that is being executed, and executing the application in a mobile terminal.

2. Description of the Related Art

As a mobile terminal has become an indispensable item to modern life style, many service providers and manufacturers are competitively developing a product (or a service).

For example, the mobile terminal has developed to a multimedia device that can provide a phonebook, a game, a Short Message Service (SMS), an Electronic (E)-mail, a morning call, a Motion Picture Expert Group Audio Layer-3 (MP3) player, a schedule management function, a digital camera, and a wireless Internet service, and more.

All the above functions are connected with a menu interface having a plurality of menu items. When a menu item is activated, the mobile terminal enters a sub menu item included in the menu item for selection. For example, when a user selects a configuration setting menu, the mobile terminal enters a configuration setting to output a plurality of sub menu items (for example: communication setting, network setting, sound setting, brightness setting, etc.). Thereafter, if the user additionally performs an operation of entering a lower sub menu (for example: communication setting), the mobile terminal outputs a menu included in the entered sub menu or performs an operation corresponding to the entered sub menu.

To view information regarding an application installed in advance in the mobile terminal or execute a different application while the user erroneously selects the entered menu item or enters a sub menu, the mobile terminal must deviate from the entered menu and enter back to a main menu. Thus, the user has an inconvenience of having to input a home button, a cancel button, or an end button.

For example, to view information regarding an installed application or execute a different application using a mobile terminal that has entered a sound setting which is a sub menu of the configuration setting, a user has an inconvenience of having to input a cancel button that proceeds to a previous step twice to enter a main screen (enter the configuration setting menu by inputting the cancel button first time, and then enter the main screen by inputting the cancel button second time), or press a home button or an end button to enter the main screen, and then view the information regarding the installed application while turning over pages of the main screen in person.

### SUMMARY OF THE INVENTION

An exemplary aspect of the present invention is to provide an apparatus and a method for simplifying a process for providing information regarding an installed application in a mobile terminal.

Another exemplary aspect of the present invention is to provide an apparatus and a method for providing application information without entering a main screen in a mobile terminal.

A further exemplary another aspect of the present invention is to provide an apparatus and a method for viewing application information via a minimum input process in a mobile terminal.

Yet, another exemplary another aspect of the present invention is to provide an apparatus and a method for simplifying an application execute process in a mobile terminal.

In accordance with an aspect of the present invention, an apparatus for providing application information in a mobile terminal includes: an application determining unit for determining information regarding an application installed in advance when detecting a request for application information under a circumstance where the mobile terminal has not entered a main screen, an output manager for outputting the determined information regarding the application on a current screen, a display unit for outputting the information regarding the application, and an application execute unit for executing an application selected by a user among the information regarding the application output on the current screen.

In accordance with another aspect of the present invention, a method for providing application information in a mobile terminal includes: determining information regarding an application installed in advance when detecting a request for application information under a circumstance where the mobile terminal has not entered a main screen, outputting the determined information regarding the application on a current screen, and after outputting the information regarding the application on the current screen, executing an application selected by a user.

In accordance with yet another aspect of the present invention, a method of displaying information in a mobile terminal includes: displaying a main menu including a plurality of applications in a main screen; in response to a selection of a particular application, displaying a sub menu including a plurality of sub menu applications in a current screen; and upon detecting a request, displaying at least one application from the main menu on a portion of the current screen while displaying the selected application.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of certain exemplary embodiments of the present invention will be more apparent to a person of ordinary skill in the art from the following description taken in conjunction with the accompanying drawings in which:

FIG. 1 is a block diagram illustrating a mobile terminal for providing application information and executing an application according to an exemplary embodiment of the present invention;

FIG. 2 is a flowchart illustrating a process for providing application information and executing an application in a mobile terminal according to an exemplary embodiment of the present invention;

FIG. 3 is a flowchart illustrating a process for providing application information and executing an application in a mobile terminal according to an exemplary embodiment of the present invention; and

FIG. 4 is a view illustrating a process for providing application information and executing an application of a mobile terminal according to an exemplary embodiment of the present invention.

Throughout the drawings, like reference numerals will be understood to refer to like parts, components and structures.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an apparatus and a method for providing application information even under a circumstance where a mobile terminal has not entered a main screen and immediately executing a different application even when the user is in a non-main screen state.

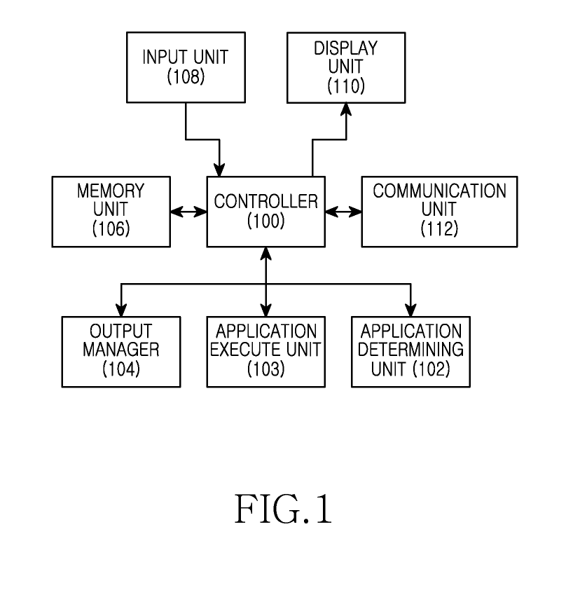

FIG. 1 is a block diagram illustrating a mobile terminal for providing application information and executing an application according to an exemplary embodiment of the present invention.

Referring to FIG. 1, the mobile terminal may include a controller/processor 100, an application determining unit 102, an application execute unit 103, an output manager 104, a memory unit 106, an input unit 108, a display unit 110, and a communication unit 112. The functionality of two or more of the above units may be integrated into a single component, and may further include additional units.

In operation, the controller 100 of the mobile terminal controls an overall operation of the mobile terminal. For example, the controller 100 performs processes and controls for voice communication and data communication. Furthermore, according to an exemplary embodiment of the present invention, when requested to output application information while not outputting a main screen, the controller 100 processes to output information regarding an application on a portion of a current output screen. In addition, the controller 100 processes to execute an application whose execution has been requested by a user among the output information regarding the application (application list).

The application determining unit 102 detects an application type(s) installed in the mobile terminal under control of the controller 100, and provides the same to the controller 100. In addition, after detecting the application type(s), the application determining unit 102 may discriminate the application type that is currently being executed and provide the outcome to the controller 100. Further, the application determining unit 102 detects the user's selection for executing the application, and provides information regarding the selected application to the controller 100.

The application execute unit 103 receives information regarding the application that the user intends to execute from the controller 100, and executes the application corresponding to the received information. That is, the application execute unit 103 immediately executes a specific application without entering a main screen. The application execute unit 103 ends a currently executed application and executes an application selected by the user.

The output manager 104 outputs information (an application type(s)) regarding an application installed in advance on a portion of a screen during a sub menu mode under control of the controller 100. The output manager 104 may discriminate a currently executed application and an unexecuted application when outputting information regarding the application.

In addition, the output manager 104 defines a portion of a currently output screen as an output region for outputting the information regarding the application under control of the controller 100, outputs a portion of the information regarding the application on the output region, and then moves the information regarding the application to a touch input direction performed by a user to provide information regarding a different application that has not been output to the currently output region.

The memory unit 106 includes Read Only Memory (ROM), Random Access Memory (RAM), and a flash ROM. The ROM stores microcodes of programs for processes and controls of the controller 100, the application determining unit 102, and the output manager 104, and various reference data.

The RAM serves as a working memory of the controller 100 and stores temporary data that occur during execution of various programs. In addition, the flash ROM stores various updatable data for storage such as a phonebook, calling messages, and received messages. The memory unit 106 stores information regarding an installed application according to an exemplary embodiment of the present invention.

The input unit 108 includes a plurality of function keys such as numerical key buttons of 0 to 9, a menu button, a cancel button, an OK button, a TALK button, an END button, an Internet access button, navigation key (or direction key) buttons, letter input keys, etc., and provides key input data corresponding to a key pressed by a user to the controller 100.

The display unit 110 displays status information generated during an operation of the mobile terminal, characters, moving images and still images, etc. The display unit 110 outputs a list of grouped APs when searching for an AP according to an exemplary embodiment of the present invention. The display unit 110 may be a color Liquid Crystal Display (LCD), an Active Matrix Organic Light Emitting Diodes (AMOLED), and other types of thin-film technology screen display apparatuses. The display unit 110 may include a touch input device, and when it is applied to a touch input type mobile terminal, it can be used as an input unit. As explained in more details, according to an exemplary embodiment of the present invention, the display unit 110 provides information regarding an application even without accessing or outputting the main screen.

The communication unit 112 transmits/receives a Radio Frequency (RF) signal of data input/output via an antenna (not illustrated). For example, during transmission, the communication unit 112 channel-codes and spreads data to be transmitted, and then performs an RF process on the signal to transmit the signal. During reception, the communication unit 112 converts a received RF signal into a baseband signal, and despreads and channel-decodes the baseband signal to recover data.

The functions of the application determining unit 102 and the output manager 104 may be performed by the controller 100 of the mobile terminal. The separate configuration and illustration of the application determining unit 102 and the output manager 104 are an exemplary purpose only for the description convenience, and not for limiting the scope of the present invention. Thus, it would be obvious to those skilled in the art that various modifications may be made within the scope of the present invention. For example, all functions of the application determining unit 102 and the output manager 104 may be processed by the controller 100.

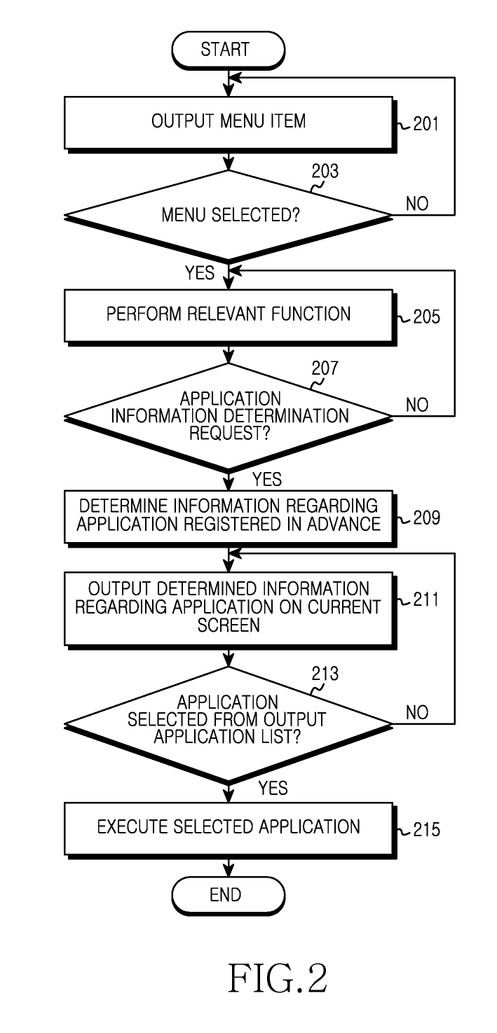

FIG. 2 is a flowchart illustrating a process for providing application information and executing an application in a mobile terminal according to an exemplary embodiment of the present invention.

Referring to FIG. 2, the mobile terminal outputs a plurality of menu items on a main screen in step 201, and then proceeds to step 203 to determine whether a user's menu selection of menu items is detected.

When there is no menu selection in step 203, the mobile terminal re-performs the process of step 201.

When detecting the menu selection in step 203, the mobile terminal proceeds to step 205 to perform a function (for example, perform a selected menu) corresponding to a menu selected by the user.

The mobile terminal proceeds to step 207 to determine whether a user's request to display the main menu is detected.

When the request is made in step 207, the mobile terminal proceeds to step 209 to determine information (for example, an application name, an application icon, etc.) regarding the applications from the main menu, and then proceeds to step 211 to output a portion of the application form the main menu in the current screen.

The mobile terminal proceeds to step 213 to determine whether an application selected by the user exists from the portion of the main menu displayed in the current screen. When the user selects a specific application therefrom, the mobile terminal may determine that the user desires to newly execute the selected application. If not, in step 213, the mobile terminal determines that the user does not wish to execute a new application, and then re-performs the process of step 211.

In contrast, when determining that the new application selected by the user exists in step 213, then proceeds to step 215 to execute the application selected in step 213. When one of applications is selected in step 213, the mobile terminal may end a currently executed application, and then execute the selected application.

As described above, the mobile terminal according to an exemplary embodiment of the present invention may immediately provide information regarding applications from the main menu to a user even while the mobile terminal has entered a sub menu or executed a specific menu, thereby enabling the user to immediately execute a specific application during any state of the sub menu windows.

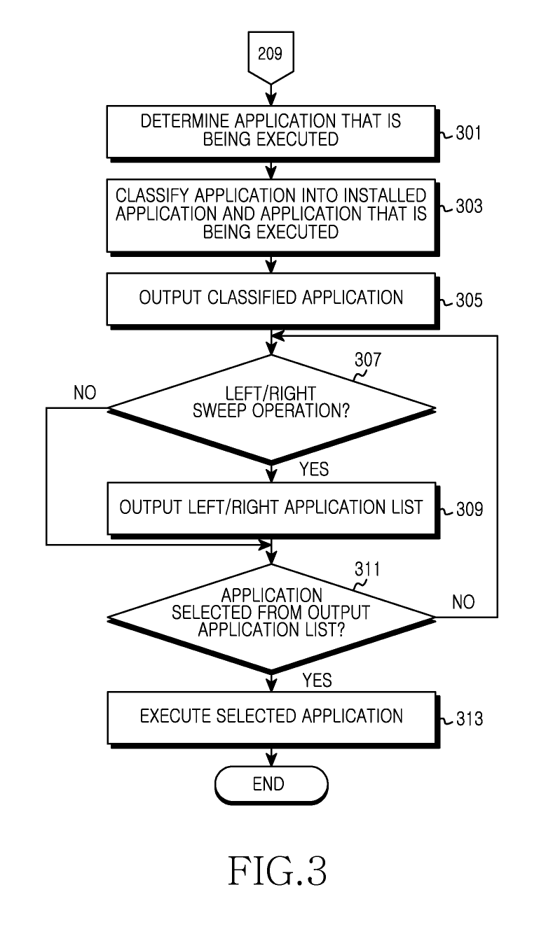

FIG. 3 is a flowchart illustrating a process for providing application information and executing an application in a mobile terminal according to an exemplary embodiment of the present invention.

Referring to FIG. 3, after determining the applications from the main menu in step 207 of FIG. 2, the mobile terminal determines information of an application that is being executed in step 301, and then proceeds to step 303 to classify the determined application into an installed application or application(s) from the main menu and an application that is being executed.

The mobile terminal proceeds to step 305 to output the application(s) from the main menu in the form of a list, and then proceeds to step 307 to determine whether the user's sweep operation for moving application(s) displayed on a portion of the display screen.

When the user's sweep operation occurs in step 307, the mobile terminal proceeds to step 309 to move the application(s) from the main menu displayed in the sub menu to a direction corresponding to the user's sweep operation.

Thereafter, the mobile terminal proceeds to step 311 to determine whether a user selects a new application

Then, the mobile terminal proceeds to execute the application selected in step 311. Here, the mobile terminal may end the application that is currently being executed and then execute the selected application.

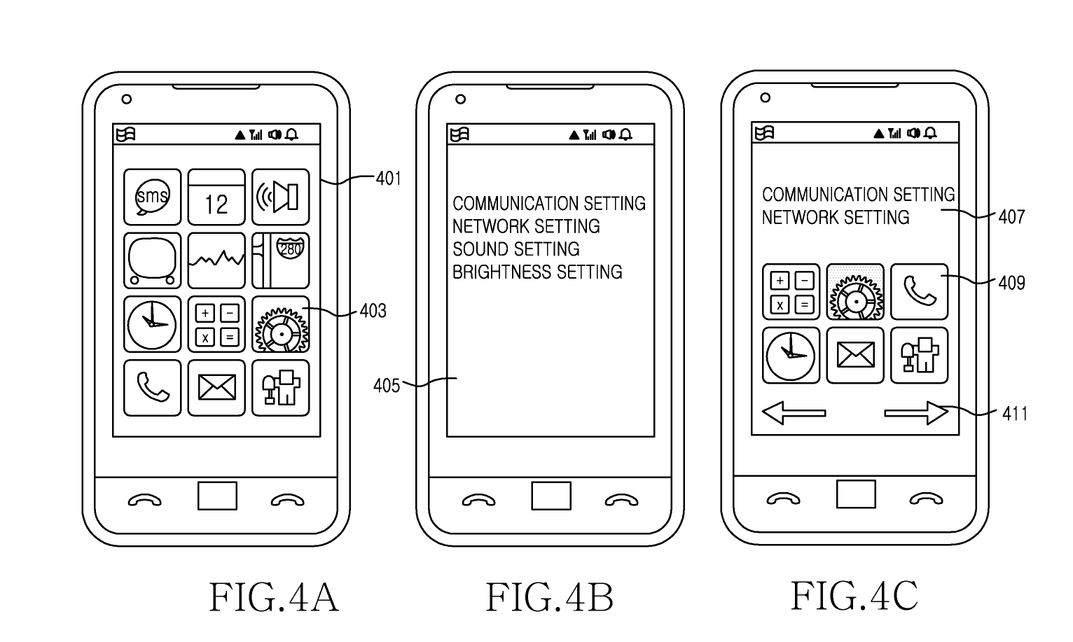

FIG. 4 is a view illustrating a process for providing application information and executing an application of a mobile terminal according to an exemplary embodiment of the present invention.

Referring to FIG. 4, the mobile terminal outputs (401) a plurality of menu items on a main screen as in FIG. 4A. When the menu item is selected, the mobile terminal enters the plurality of sub menu items included in the menu item. For example, when a user of the mobile terminal selects a configuration setting menu 403, the mobile terminal enters a configuration setting to output (405) a plurality of sub menu items (for example, communication setting, network setting, sound setting, brightness setting, etc.) included in the configuration setting menu, as shown in FIG. 4B.

To view information regarding an application that is currently being executed or information regarding an application installed in advance or main menu while in a sub menu mode as described above, instead of going back to the main menu via inputting a cancel key or an end key, a user can request to display a portion or full image of the main menu on the current window.

For example, as illustrated in FIG. 4C, when detecting an application information request via a user's touch input in a state 407 of entering a configuration setting, the mobile terminal according to an exemplary embodiment of the present invention outputs information of the main menu on a current screen 407 (screen in a state of entering a sub menu).

Here, in FIG. 4B and FIG. 4C, the user may activate a predetermined key button among the key buttons to make a request to show the portion of the menu screen. The key button may be a press type key button or a touch type key button. Also, the user may use a verbal request show the portion of the menu screen. The verbal request may be performed using a voice recognition method known to this technical filed.

In the embodiment, as shown in FIG. 4c, the mobile terminal provides the information of the installed applications provided from the main menu that are adjacent or around an application that is being executed the sub menu. Here, providing information regarding applications in the main menu (i.e., applications related to the upper menu) around or adjacent to currently entered submenu is preferred as an application corresponding to a normal menu entry may exist in this neighborhood in the case where a user erroneously inputted adjacent menus in the previous step.

Further, the mobile terminal may classify applications into an application(s) available from the main menu and an application that is currently being executed in the mobile terminal. FIG. 4C discriminates the currently executed application from the applications in the main menu by, for example, shading (shaded configuration setting menu) the currently executed application.

In addition, since the mobile terminal cannot output information regarding all applications of the main menu on the output region, a direction button 411 is provided to enable the user to browse or navigate the rest of the applications. Alternatively, the mobile terminal may move, browse, or navigate applications using a finger sweep operation on the screen instead of the direction button 411.

Thereafter, upon detecting a specific application selection 409, for example, on the current screen by a user, the mobile terminal processes to execute the selected application.

As described above, the exemplary embodiments of the present invention provide an apparatus and a method for simplifying a process of providing application information and a process of executing an application. In the case where a user's request occurs regardless of the position of the entered menu, the apparatus and the method may reduce the user's input process for entering a main screen by outputting information regarding an application installed in advance (or applications on the main menu) on the current screen (for example, a screen in a state of entering a sub menu) according to a predetermined criteria. Accordingly, the apparatus and the method according to the exemplary embodiment of the present invention may select application information output on a screen, not of the main screen, to execute a specific application.

The above-described methods according to the present invention can be implemented in hardware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A terminal for providing application information, comprising:
a display; and
a controller for determining information regarding at least one application from a main menu in response to a request when a sub menu is displayed on a current screen of the display and displaying the determined information on a portion of the current screen.

2. The terminal of claim 1, wherein the display displays an application that is currently being executed and the determined information in the current screen.

3. The terminal of claim 4, wherein displaying the determined information on the portion of the current screen comprises displaying applications from the main menu adjacent to the application that is currently being executed in the current screen.

4. The terminal of claim 1, wherein the currently executed application is visually differentiated from the determined information in the current screen.

5. The terminal of claim 1, wherein the content of the determined information displayed on the current screen is browsed according to a sweep operation on the display.

6. The terminal of claim 1, wherein the display further displays an arrow icon to browse the determined information displayed in the current screen.

7. The terminal of claim 1, wherein the information regarding the at least one application comprises at least one of the application's name, an icon, and category information corresponding to the application.

8. A method for providing application information in a mobile terminal, the method comprising:
displaying a main menu in a main screen and displaying a sub menu in a current screen in response to a selection of a particular program;
determining information regarding at least one application from the main menu in response to a request when the mobile terminal is displaying the sub menu; and
outputting the determined information on a portion of the current screen.

9. The method of claim 8, wherein the outputting of the determined information on the current screen further comprises:
displaying an application that is currently being executed in the sub menu.

10. The method of claim 9, wherein the application that is currently being executed and in the sub menu is visually displayed differently.

11. The method of claim 8, wherein the content of the determined information is moved according to a sweep operation detected on the current screen.

12. The method of claim 8, further comprising displaying an arrow icon to browse the determined information displayed in the current screen.

13. The method of claim 8, wherein displaying the determined information on the portion of the current screen comprises displaying applications from the main menu adjacent to the application that is currently being executed from the submenu.

14. The method of claim 8, wherein the information regarding the at least one application comprises at least one of the application's name, an icon, and category information corresponding to the application.

15. A method of displaying information in a mobile terminal, comprising:
displaying a main menu including a plurality of applications in a main screen;
in response to a selection of a particular application, displaying a sub menu including a plurality of sub menu applications in a current screen; and
upon detecting a request, displaying at least one application from the main menu on a portion of the current screen while displaying the selected application.

16. The method of claim 15, wherein the content of the portion of the current screen is navigated according to a sweep operation detected on the current screen.

17. The method of claim 8, further comprising displaying an arrow icon to browse the content of the portion of the current screen.

18. The method of claim 8, wherein displaying the portion of the current screen comprises displaying applications from the main menu adjacent to the application corresponding to the submenu application.

19. The method of claim 8, wherein the information regarding the at least one application comprises at least one of the application's name, an icon, and category information corresponding to the application.
